(19) United States
(12) Patent Application Publication
(10) Pub. No.: US 2026/0111868 A1
(43) Pub. Date: Apr. 23, 2026

(54) SYSTEMS AND METHODS TO FACILITATE TARGET BRIDGING

(71) Applicant: TBCASOFT, INC., Sunnyvale, CA (US)

(72) Inventors: Shieng-Chyuarn JANG, Newark, CA (US); Dennis WONG, Fremont, CA (US); Simon MA, Mountain View, CA (US)

(21) Appl. No.: 19/117,062

(22) PCT Filed: Oct. 2, 2023
(86) PCT No.: PCT/US2023/075755

§ 371 Date: Mar. 30, 2025

Related U.S. Application Data
(60) Provisional application No. 63/378,050, filed on Sep. 30, 2022.

(51) Int. Cl. G06Q 20/32; G06Q 20/02; G06Q 20/40

(52) U.S. Cl. CPC G06Q 20/3276; G06Q 20/02; G06Q 20/40

(57) ABSTRACT

The present invention relates to a system and method for target bridging between a portable device of a payer of a first service provider and a merchant device of a receiver of a second service provider different from the first service provider. An emulator system is used to login the payment system of the second service provider with a bridging account, so that the first service provider may conduct transactions with the second service provider via the bridging account, even if the first service provider runs a target format different from the second service provider.

### BACKGROUND OF THE INVENTION

### Related Application

This application claims the benefit of the U.S. Provisional Application No. 63/378,050 filed on Sep. 30, 2022, titled “SYSTEMS AND METHODS TO PROCESS TARGETS,” which is incorporated herein by reference at its entirety.

### FIELD OF THE INVENTION

The present invention relates to a system and method to enable transactions between two payment service providers with different target format, especially for two mobile payment service providers (MPSPs) with different transaction QR-code format.

### DESCRIPTION OF RELATED ART

QR code payment is a contactless payment method performed by scanning a QR code from a mobile app or from a merchant point of sale (POS) system. There are two types of QR code payment methods, merchant presented mode (MPM) and consumer presented mode (CPM), which are different in the party who presents the QR code for the counterparty to scan. In merchant presented mode (MPM), the consumer scans the QR code displayed by the merchant with their smartphone to pay. On the contrary, in consumer presented mode (CPM), the merchant scans the QR code displayed by the consumer to receive the payment. With QR code payment, a transaction can be done even without the infrastructure traditionally associated with electronic payments, such as payment cards, payment networks, payment terminal and merchant accounts.

A Mobile Payment Service Provider (MPSP) is a closed-loop payment network which can provide QR code payment services. In such a closed-loop network, a system of any MPSP can facilitate the transactions between users and merchants as long as they are both in the MPSP network. If users and merchants are from different networks, it is impossible to perform the transactions since their respective QR codes are not recognizable by the other party's system. In other words, both user and merchant need to be in the same MPSP network in order to facilitate the payment transactions.

If cross-MPSP transactions are desired, it will require a common payment interface such as common targets, integrated systems, and APIs. There are implementations using a national QR standard to display a conformed merchant QR (MPM) for participating MPSPs users to scan and pay. This method, however, is hard to generalize to all MPSP because it lacks incentives for a MPSP to apply such standard.

### SUMMARY OF THE INVENTION

Provided herein is a method to execute a transaction between the systems of two MPSPs (one serves as an issuer, and one serves as an acquirer). This can be done when the issuer has at least one valid account, Issuer General Account (IGA), with the acquirer.

In one aspect, the present invention provides a method for target bridging between a portable device of a payer of a first service provider and a merchant device of a receiver of a second service provider different from the first service provider, comprising steps of: (1) wirelessly receiving, by a first management system of the first service provider, a target or a target content of the second service provider from a portable device of the payer; and (2) sending, by the first management system of the first service provider, the target or the target content of the second service provider, to an emulator system, so that the emulator system resolves the target or the target content and transmits the resolved target or the target content of the second service provider to a second management system of the second service provider. In this method the portable device is configured to scan the target of the second service provider and transmit the target or the target content of the second service provider to the first management system; the portable device does not recognize a target of the second service provider; and the emulator system recognizes a target of the second service provider. In one embodiment, the target is a QR code.

Before sending the target or the target content of the second service provider to the emulator system, the method may further comprise identifying the second service provider from multiple acquirers. In one embodiment, the second service provider is identified from the multiple acquirers by receiving an identity information. In another embodiment, the second service provider is identified from the multiple acquirers by performing pattern matching on the target against an acquirer logo library.

The second aspect of the present invention is to provide a second method for target bridging between a portable device of a payer of a first service provider and a merchant device of a receiver of a second service provider different from the first service provider, comprising steps of: (1) receiving, by a first management system of the first service provider, a target or a target content of the second service provider, from an emulator system; and (2) wirelessly providing, by the first management system of the first service provider, the target or the target content of the second service provider, to the portable device of the payer to present the target to the merchant device of the receiver of the second service provider. In this method the emulator system can generate or receive the target or the target content of the second service provider; and the merchant device of the receiver does not recognize a target of the first service provider. In one embodiment, the target is a QR code.

Before receiving the target or the target content of the second service provider, the method may further comprise: (1) wirelessly receiving, by the first management system, a target request from the portable device of the payer for the target of the second service provider; and (2) providing, by the first management system, the target request to the emulator system. In one embodiment, before providing the target request to the emulator system the method further comprises identifying the second service provider from multiple acquirers. The second service provider may be identified from the multiple acquirers by receiving an identity information, or may be identified from the multiple acquirers by performing pattern matching on the target against an acquirer logo library.

For transaction approval, the method may further comprise (1) receiving a transaction request from the emulator system; and (2) providing a transaction approval approving the transaction request to the emulator system.

To process transaction in the first service provider's network, the method may further comprise (1) receiving, by the first management system, a transaction result from the emulator system; (2) processing, by the first management system, a payment from the payer to the first service provider corresponding to the transaction result; and (3) wirelessly providing, by the first management system, the transaction result to the portable device of the payer.

The third aspect of the present invention is to provide a third method for target bridging between a portable device of a payer of a first service provider and a merchant device of a receiver of a second service provider different from the first service provider, comprising steps of: (1) receiving, by an emulator system, a target or a target content of the second service provider, from a first management system of the first service provider; (2) resolving, by the emulator system, the target or the target content of the second service provider; and (3) providing, by the emulator system, the resolved target or the target content of the second service provider, to a second management system of the second service provider, via a bridging account as a member of the second service provider. In one embodiment, the target is a QR code.

Before receiving the target or the target content of the second service provider from the first management system, the method may further comprise receiving an identity information of the second service provider selected from multiple acquirers.

The fourth aspect of the present invention is to provide a fourth method for target bridging between a portable device of a payer of a first service provider and a scanning system of a receiver of a second service provider different from the first service provider, comprising steps of: (1) retrieving, by an emulator system, a target or a target content of the second service provider via a bridging account as a member of the second service provider; and (2) providing, by the emulator system, the target or the target content of the second service provider, to the first management system of the first service provider, so that the portable device of the payer presents the target generated based on the target content to the merchant device of the receiver, which recognizes the target of the second service provider. In this method, the merchant device of the receiver does not recognize a target of the first service provider. In one embodiment, the target is a QR code.

Before retrieving the target or the target content of the second service provider, the method may further comprise: (1) receiving, by the emulator system, a target request from the first management system for the target of the second service provider; and (2) providing, by the emulator system, the target request to the second service provider via the bridging account.

In one embodiment, an identity of the second service provider selected from multiple acquirers is provided along with the target request, and the bridging account is corresponding to the second service provider.

To conduct a bridging transaction, the method may further comprise: (1) receiving a transaction request from the second management system after the merchant device of the receiver scans the target; (2) providing the transaction request to the first management system; (3) receiving a transaction approval approving the transaction request from the first management system; and (4) providing the transaction approval to the second management system via the bridging account. After providing the target or the target content of the second service provider to the first management system, the method may further comprise: (1) receiving a transaction result from the second management system via the bridging account; and (2) providing the transaction result to the first management system.

In one embodiment, the emulator system is operated in the first management system. In another embodiment, the emulator system is operated in a bridging system of a bridging service provider different from the first service provider and the second service provider.

In one embodiment, the emulator system logs in the second management system of the second service provider with a bridging account as a member of the second service provider. The emulator system may have multiple emulator accounts registered in the multiple acquirers, and the bridging account may be selected from multiple emulator accounts.

The fifth aspect of the present invention is to provide an emulator system for target bridging between a portable device of a payer of a first service provider and a merchant device of a receiver of a second service provider different from the first service provider, comprising: (1) an execution module, configured to communicatively connect to at least one issuer management system; and (2) an emulator module communicatively connected to the execution module, configured to communicatively connect to multiple acquirer management systems. The execution module comprises instructions stored thereon configured to, in response to execution of the instructions, perform operations comprising: (1) receiving an input from a first management system, which is one of the at least one issuer management system; (2) identifying, based on the input, a second management system from the multiple acquirer management systems; (3) providing, based on the second management system, the input to the emulator module; (4) receiving an output from the emulator module; and (5) providing the output to the first management system. The emulator module is configured to login the multiple acquirer management systems with multiple emulator accounts, each of which is registered in one of the multiple acquirer management systems. In one embodiment, the input is a target request, and the output is a target or a target content of the second management system. In another embodiment, the input is a target or a target content of the second management system, and the output is a payment request initiated by the second management system.

In the emulator system, the emulator module may run mobile apps of multiple acquirers to login the multiple acquirer management systems. The emulator system is configured to record an identity of the first management system and an identity of the payer upon receiving the input. Any of the multiple acquirer management systems does not recognize a target of each other's.

Other objectives, advantages and novel features of the invention will become more apparent from the following detailed description when taken in conjunction with the accompanying drawings.

### BRIEF DESCRIPTION OF THE DRAWINGS

FIG. 1 shows the system facilitates bridging transaction in the present invention.

FIG. 2 shows the process flow of a merchant presented mode (MPM) bridging transaction.

FIG. 3 shows the process flow of a consumer presented mode (CPM) bridging transaction.

FIG. 4A shows a network of 6 MPSPs performing target bridging method independently; FIG. 4B shows a network of 6 MPSPs performing target bridging method via a bridging service provider (bridging SP).

FIG. 5 shows a modified embodiment of the system facilitates bridging transaction in the present invention.

FIG. 6 shows the process flow of a modified merchant presented mode (MPM) bridging transaction with a bridging service provider.

FIG. 7 shows the process flow of a consumer presented mode (CPM) bridging transaction with a bridging service provider.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), graphics processing units (GPUs), etc.

This application relates to a method to facilitate transactions between two mobile payment service providers (MPSPs) with different target formats. Targets are mediums containing information which can be recognized by specific devices. Examples include but are not limited to one of barcode, QR code, NFC (Near-field Communication) tag, voice signature, and fingerprint. The target itself is information derived by extracting features embedded in the original target information, for example, by scanning QR code, sensing NFC tag, extracting voice signature from voice, or scanning fingerprint to extract the features and obtain the target according to the scheme of the original target information. In an embodiment of the present invention, the target is a QR code.

As described above, there are two different MPSPs participating in a cross-MPSP transaction, with one of them being an issuer and another one being an acquirer. An issuer is a financial institution that supplies a consumer with a payment tool they use to initiate a transaction. On the other hand, an acquirer is a financial institution that provide a merchant with the tools needed to collect payment from issuers. In this framework, the consumer is usually a payer, and the merchant is usually a receiver. Depending on its role in different transactions, a financial institution may sometimes act as an issuer and sometimes act as an acquirer. In this specification, the mobile payment service provider (MPSP) on the consumer side of a cross-MPSP transaction (the issuer) is called first service provider (1^{st} SP), and the MPSP on the merchant side (the acquirer) is called second service provider (2^{nd} SP).

To communicate with the acquirer, the issuer creates at least one valid account, Issuer General Account (IGA), with the acquirer. When communicating with the acquirer, the system of issuer (which is called first management system) can either use the above registered account, IGA, or a token associated with the above registered account or securely encrypted registered account. In the subsequent sections, IGA means the Issuer General Account or its token or its encrypted form, interchangeably.

To enable the issuer and its user to present or recognize targets of the acquirer (which is an MPSP with different target format), the issuer establishes an emulator system that is similar to the mobile app provided by the acquirer to its users, and the IGA is used as the login account. The IGA used in the emulator system to login the acquirer's system is called an emulator account. The emulator account is the same as other members from acquirer's point of view, and the emulator system can execute all functions of the mobile app. Namely, the mobile app may be installed on the emulator system as if it is a normal mobile device, except that the emulator system may have the capability of linking user identities, targets, transaction details and passing required data to different parties involved in the transaction. The emulator system is employed to execute transactions with the acquirer for users of the issuer.

### Framework of Bridging Transaction System

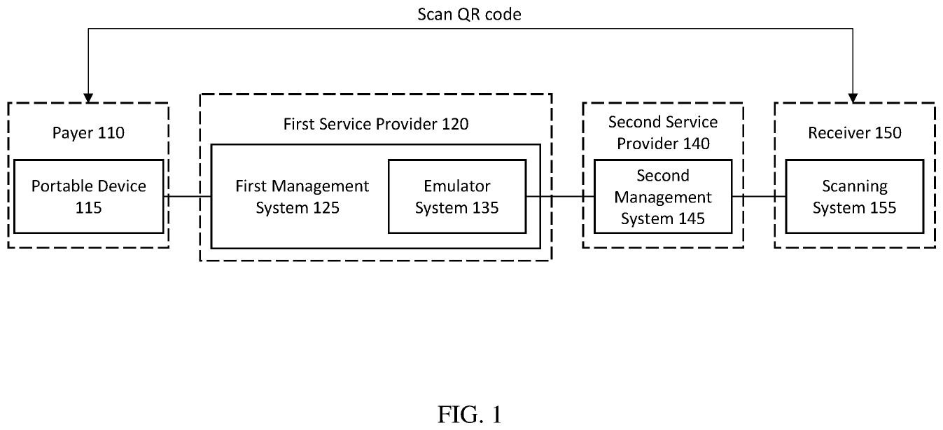

A cross-MPSP transaction is called a bridging transaction, and a system allowing such cross-MPSP transactions is called a bridging transaction system, as shown in FIG. 1. The bridging transaction system comprises two main participants: the first service provider 120 (the issuer) and the second service provider 140 (the acquirer). The payer 110 is a user of the first service provider 120 and has a registered account in the first service provider 120. The portable device 115 of the payer 110 is a device having the ability to connect to the Internet and execute programs of the first service provider 120 to present and scan targets (e.g., QR codes). Commonly used portable devices include but not limited to smartphones and tablets. The portable device 115 wirelessly connected to a first management system 125 of the first service provider 120, wherein the first management system 125 is an operating system of the first service provider 120. Besides all functions of normal MPSP's operating systems, the first management system 125 also comprises an emulator system 135 to execute bridging transaction-related functions. A normal mobile app of the second service provider 140 may be installed on the emulator system 135 so that the emulator system 135 can act as a member of the second service provider 140, where the emulator system 135 uses an emulator account as the login account to participate in the payment network of the second service provider 140 (the acquirer). The second service provider 140 has a second management system 145, which is an operating system performing functions of a normal MPSP. The receiver 150 (e.g., a merchant) uses a merchant device 155 (e.g., a smartphone, a tablet, or a merchant POS system) to connect with the second management system 145 and the payment network of the second service provider 140.

As described above, the emulator account is the same as other members from the second service provider's point of view. When the payer 110 (usually a consumer) wants to make a payment to a receiver 150 (usually a merchant), the payer 110 transmits a payment request to the first management system 125 from his/her portable device 115. The first management system 125 then relays the request to a second management system 145 of the second service provider 140 via the emulator system 135, wherein the second management system 145 is an operating system of the second service provider 140. The second management system 145 treats the emulator account the same as other members of the second service provider 140, such as the receiver 150. The second service provider 140 receives the payment request from the emulator account and execute the payment to the receiver 150. In this system, the payer 110 pays the first service provider or the emulator account in the payment network of the first service provider 120, and the emulator account pays the receiver in the payment network of the second service provider 140.

If the first service provider 120 holds multiple emulator accounts in different MPSPs (acquirers), the payer 110 may select one of those MPSPs (acquirers) as the second service provider 140. For example, the user app of the first service provider 120 may provide a list of acceptable MPSPs (acquirers) based on geo-location on the portable device 115, and the payer 110 may select one MPSP which can be accepted by the merchant 150. The selection list of the MPSPs can be programmable or pre-defined based on preference or incentives or other business needs. Alternatively, the selection process may also be automated. For example, the user app of the first service provider 120 may enable the payer 110 to scan logos of MPSPs and automatically select one as the second service provider 140 if the user app recognizes any. The first service provider 120 then may use one of the multiple emulator accounts as a bridging account to perform functionality of a bridging transaction with the selected second service provider 140.

### Emulator System and Emulator Account

The emulator system 135 is similar to the mobile app provided by the second service provider 140 to its users. However, only the first management system 125 (instead of any single user) can transmit data to or receive data from the second management system 145 via the emulator system 135. The first service provider 120 creates an emulator account in the payment system of the second service provider 140 to interact with other members of the payment system. In the payment system of the second service provider 140, the emulator account is an account registered by the first service provider 120 and acts like a normal member of the second service provider 140. The emulator system 135 can get access to data transmitted to the emulator account from the second management system 145.

The emulator system performing functionality of bridging transactions may comprise an execution module and an emulator module. The two modules may be communicatively connected to each other. In this case, the execution module is the part connects to issuers (e.g., the first service provider), and the emulator module is the part connects to acquirers (e.g., the second service provider). The emulator system may be run by an issuer (e.g., the first service provider) as a part of the issuer system, or it may be run by a bridging service provider which is neither an issuer nor an acquirer (which will be described in more details below). The emulator module may perform functions of one or more acquirer's mobile apps. The emulator system may use registered accounts of acquirers called emulator accounts to login acquirer's system (e.g., the second management of the second service provider). The emulator system may connect to multiple acquirers so that an issuer can conduct bridging transactions with the multiple acquirers. In the case where the emulator system is run by a bridging service provider, it may also connect to multiple issuers to provide bridging service to the multiple issuers.

The emulator module in the emulator system may simply be a mobile app of an acquirer installed in an emulator which emulates the environment of a mobile phone. Alternatively, the emulator module may also be designed as an integrated module which runs the functions of multiple acquirers' apps (in the case that developing such an integrated module is permitted by the multiple acquirers, and so that the module can send and receive data just like a normal mobile app). The execution module is configured to send an input transmitted by the payer into the mobile app, and retrieve the data received by the mobile app as an output. In more detail, the functions performed by the execution module may include but not limited to: (1) receiving an input from a first management system, which is one of the at least one issuer management system; (2) identifying, based on the input, the second service provider from the multiple acquirers; (3) providing, based on the identity of the second service provider, the input to the emulator module; (4) receiving an output from the emulator module; and (5) providing the output to the first management system. The identity of the second service provider is used to direct the input from the first service provider to the correct second service provider. In the embodiment of CPM bridging transaction, the input described above may be a target request, and the output may be a target or a target content of the second management system. In the embodiment of MPM bridging transaction, the input may be a target or a target content of the second management system, and the output may be a payment request initiated by the second management system. In one embodiment, the functions of an execution module and an emulator module described above may further be integrated in a single module.

In one embodiment, a mobile app of an acquirer is installed in the emulator system, and the emulator may have one or more of the following functions. The emulator may emulate the look and feel of all functions and features of a mobile device using the intended mobile payment app, so that the acquirer app can work normally as is it is installed in a mobile device. The emulator may capture and pass through the contents, including target contents (e.g., QR images), between the emulator and interfaces to and from payer's app and the acquirer app (in the emulator), so that the payer can present or scan an acquirer target to perform transactions with a receiver of the acquirer. The emulator may be integrated with issuer's other business systems, such as financial system, transaction decision system, fraud/risk system, user profile system, and others, so that the payer may conduct transactions with the receiver similar to transactions within issuer's payment system. The emulator may programmatically navigate and identify the various “screens” of the acquirer app and its contents and data entry fields if multiple copies of the app is installed in the emulator. The emulator may also interact with acquire app on prompts such as confirmation, exception, and/or error handling.

In one example, the receiver 150 presents a target (such as a transaction QR code in merchant presented mode transaction), the payer 110 then scans the target, and transmits the target to the emulator system 135 via the first management system 125. In an example, the target is an intact QR code image. The emulator system 135 then “scans” the received target to initiate a payment request using the identity of the emulator account in the payment system of the second service provider 140. After receiving the payment request, the second management system 145 can execute such transaction based on the target information.

In another example, when the receiver 150 requires a target (such as a transaction QR code in consumer presented mode transaction) to proceed with a transaction, the emulator system 135 will generate such a target with the emulator account's identity. Then the emulator system transmits the generated target to the portable device 115 of the payer 110 via the first management system 125. An example of the transmitted target is an intact QR code image for receiver to scan. The payer 110 then may be able to present the target to the receiver 150 for scanning. After scanning, the merchant device 155 (such as a POS system) of the receiver 150 will transmit the target information to the second management system 145 to execute a transaction.

### Properties of Emulator Account

The emulator account, or emulator account number, is a master account similar to a corporate account in the credit card industry, where the corporate account has many authorized users (employees). Password may be required and associated with emulator account to be able to log into the mobile app of the acquirer (the second service provider). The password for emulator account is highly secured. It can be protected with encryption, stored in a vault similar to Secure Element in iOS, with constant rotations of new passwords. In one embodiment, an emulator account is not transmitted in the original value or format to users of both the issuer and the acquirer.

When communicating with the acquirer, the issuer can either use the above registered account, emulator account, or a token associated with the above emulator account. The token can also be securely encrypted. Depending on the system and communication setup in the mobile app of the acquirer, emulator account can be tokenized to provide better security. emulator account may also have Time To Live (TTL) features similar to expiration dates on credit cards.

Since emulator account is used for multiple transactions from various users, the emulator system may be configured to link original transactions from the issuer (first service provider) side to the transactions in the acquirer (second service provider) side. A pending transaction may be created once a payer initiates the transaction. The transaction can be updated based on the response from the actual transaction in the second management system of the acquirer. In one embodiment of CPM, a requested target is tied back to the original payer and/or transaction request.

In addition, many emulator accounts can be created in a single acquirer (the second service provider) to (1) alleviate transaction volumes, (2) avoid transaction collisions, (3) provide redundancy to avoid single point of failure, and (4) prevent account takeover. For example, if many bridging transactions to the same acquirer is requested, different emulator accounts may be assigned to different payers for transactions, since each of the emulator accounts registered in the acquirer may not be allowed to execute multiple transactions at the same time. The account selected from the multiple emulator accounts to conduct a transaction with acquirer is called bridging account.

When transmitting targets (such as QR codes) from merchants (MPM) or users (CPM), the targets can be encrypted to avoid MITM (man-in-the-middle) attacks. An added security feature is to attach or associate the transaction amount to or with the target that can be used as a second layer confirmation. The methods of emulator account encryption will be described with more details below.

### Process for Merchant Presented Mode Bridging Transactions

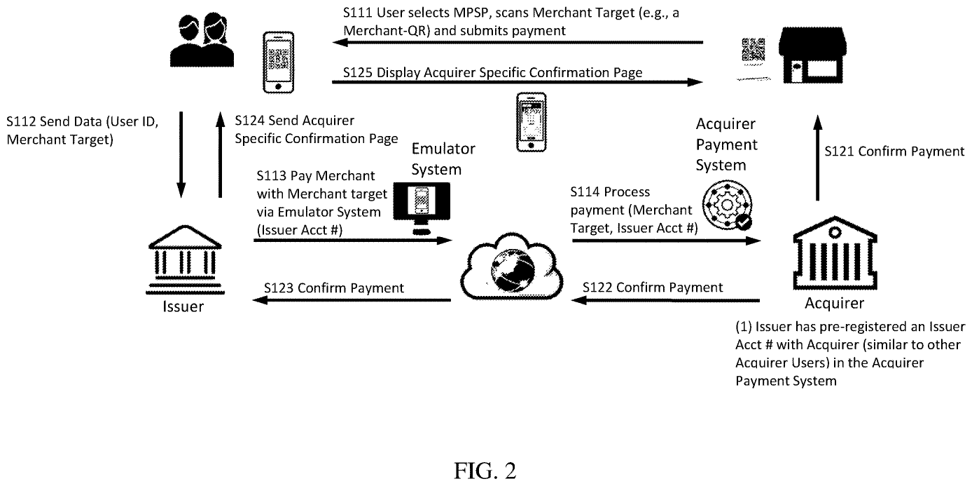

The process for a merchant presented mode (MPM) bridging transaction is as shown in FIG. 2 and described in detail below. The issuer (the first service provider) has registered emulator accounts with multiple available acquirers, wherein each of the available acquirers has at least one emulator account registered in its network.
S111: A payer browses on the mobile app to select an acquirer (i.e., select a second service provider) from a list of acceptable MPSPs in a region (e.g., Japan); The payer then scans a merchant target (such as a merchant QR code) and enters the transaction amount then submits the payment.
S111(a) and S111(b) describe a variation on merchant store confirmation.
S111(a): Alternatively, the payer can first scan and pass the merchant target to the emulator system to resolve and confirm the merchant information.
S111(b): The emulator system then sends the merchant information to the payer to confirm, and the payer enters the transaction amount. If the merchant target already contains the transaction amount, then the payer only needs to confirm the payment and needs not to enter the transaction amount.
S112: The payer sends the user identifier (user ID) and merchant target to the first management system (1^{st} MS) of the issuer, along with the transaction amount.
S113: The 1^{st} MS resolves user ID and records the transaction data in the issuer's payment system; then the 1^{st} MS uses the issuer's registered emulator account (which is called bridging account) to log in and perform a transaction use or scan merchant target, with detailed transaction info such as the payment currency and amount.
S114: The second management system (2^{nd} MS) of the acquirer (the second service provider) performs the payment request using existing processes with user (in IGA), merchant (resolving merchant target) with other payment info such as currency and amount.
S121: The 2^{nd} MS confirms payment transaction to merchant if applicable.
S122: The 2^{nd} MS confirms payment transaction to the emulator system.
S123: The 1^{st} MS extracts payment confirmation from the emulator system sent from the 2^{nd} MS.
S124: The 1^{st} MS sends a payment confirmation to the portable device of the payer. The payment confirmation may be an acquirer specific confirmation page information, which may be generated in the emulator system and transmitted to the portable device via the 1^{st} MS.
S125: The payer may present the acquirer specific confirmation page information if he/she receives one from the 1^{st} MS, or if the mobile app of the issuer can generate one based on the transaction result. Alternatively, the acquirer specific confirmation page may not be required if the receiver can confirm the transaction result via the merchant device.

### Process for Consumer Presented Mode Bridging Transactions

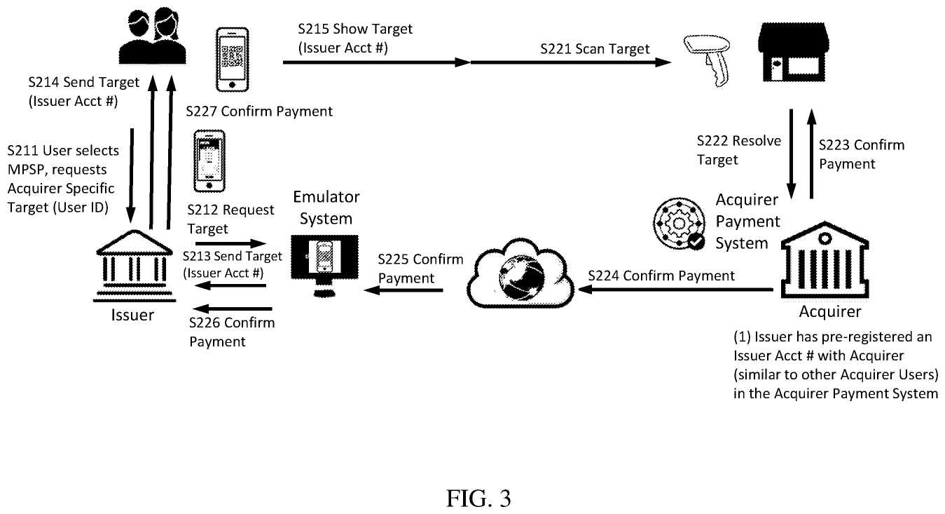

The process for a consumer presented mode (CPM) bridging transaction is as shown in FIG. 3 and described in detail below. Similar to MPM, the issuer (the first service provider) has registered emulator accounts with multiple available acquirers, wherein each of the available acquirers has at least one emulator account registered in its network.
S211: The payer browses on the mobile app to select an acquirer (select a second service provider) from a list of acceptable MPSPs in a region (e.g., Japan); then the payer requests a target (e.g., a QR code) from the issuer that the receiver (e.g., an acquirer merchant) can scan and accept.
S212: The first management system (1^{st} MS) of the issuer sends target request to the emulator system.
S213: The emulator system generates a target based on the bridging account (which is the emulator account used to login 2^{nd} MS).
S214: The 1^{st} MS sends the generated target to the portable device of the payer. Depending on the Acquirer Mobile App setup or the feature implemented by the Issuer, the target can be time based (TTL-Time To Live), tokenized, or encrypted uniquely that only the intended mobile user can decrypt the target.
S215: The portable device of the payer displays the target to the merchant device (e.g., a merchant POS) of the receiver.
S221: The receiver scans the target.
S222: The target or the target content is sent to the second management system (2^{nd} MS) of the acquirer (the second service provider).
S223: The 2^{nd} MS resolves the target and receiver info and confirms the payment transaction to the receiver.
S224: The 2^{nd} MS confirms payment.
S225: The 2^{nd} MS confirms payment to the emulator system.
S226: The 1^{st} MS extracts payment confirmation from the emulator system.
S227: The portable device of the payer receives payment confirmation(s) from the 1^{st} MS. The payment confirmation(s) may be in the format of the issuer, or in the format of the acquirer, or both. Similar to S125, the payment confirmation in the format of the acquirer is an acquirer specific confirmation page information, which may be generated in the emulator system and transmitted to the portable device via the 1^{st} MS.

### Emulator Account Encryption

The emulator account may be encrypted by various methods. One of the methods for emulator account encryption is to use mobile device ID as the encryption key that only the receiving mobile device can decrypt in the CPM flow. The mobile device ID is sent in S211 in CPM when a user first requests for a target. The emulator system may use the mobile device ID as an encryption key to encrypt the target before S213. The portable device of the payer then may use its device ID to decrypt the target before S215 showing target to the merchant.

Using iOS environment implemented in iPhone as an example, any of the following IDs may be used as the encryption key:
SEID (Secure Element Identifier): This is a unique identifier for the secure element chip in Apple devices, which is used for storing sensitive data like credit card information and biometric data.
EID (Enterprise Identifier): This is a unique identifier used by enterprises to manage and deploy Apple devices within their organization.
IMEI (International Mobile Equipment Identity): This is a unique 15-digit code used to identify GSM and WCDMA mobile phones. It's used by mobile networks to identify valid devices and prevent fraudulent activity.
ICCID (Integrated Circuit Card Identifier): This is a unique 19-20 digit code used to identify SIM cards. It's used by mobile networks to authenticate and activate SIM cards.
MEID (Mobile Equipment Identifier): This is a unique 14-digit code used to identify CDMA mobile phones. It's similar to the IMEI used for GSM and WCDMA phones.
IMEI2: This is a second IMEI number that some dual-SIM phones have, which allows them to use two different SIM cards simultaneously.

### Bridging Transactions With a Bridging Service Provider

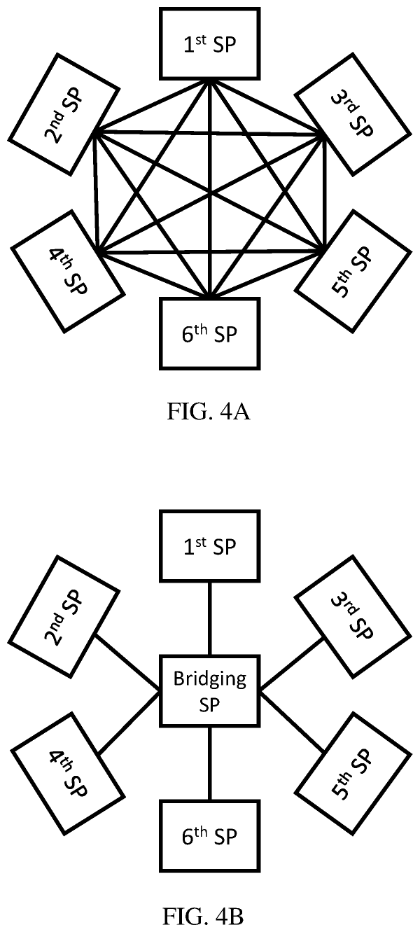

An issuer needs to create at least one emulator account in every acquirer which it would like to establish bridging transactions with. Therefore, when an issuer decides to implement this method at various markets of N acquirers, the issuer needs to set up at least N emulator accounts. Similarly, if there are M issuers connecting to one single acquirer, then the acquirer needs to manage at least M accounts. With many MPSPs in each country, this becomes a multiplication problem. FIG. 4A shows an example of 6 MPSPs. If all of the 6 MPSPs would like to implement the system for bridging transactions with other 5 MPSPs, each of them would need to run an emulator system with functionality of 5 MPSP mobile apps (or run 5 independent emulator systems for each of the 5 mobile apps). As a result, at least 30 copies of mobile apps and 30 emulator accounts are run in the whole network. And if there are 100 MPSPs hoping to implement the above system and method for bridging transactions, any of the MPSPs would have to run at least 99 emulator accounts in its system to enable bridging transactions with all other MPSPs. If someone can serve as a node between all MPSPs, as the “bridging service provider (bridging SP)” shown in FIG. 4B, the network will be more concise.

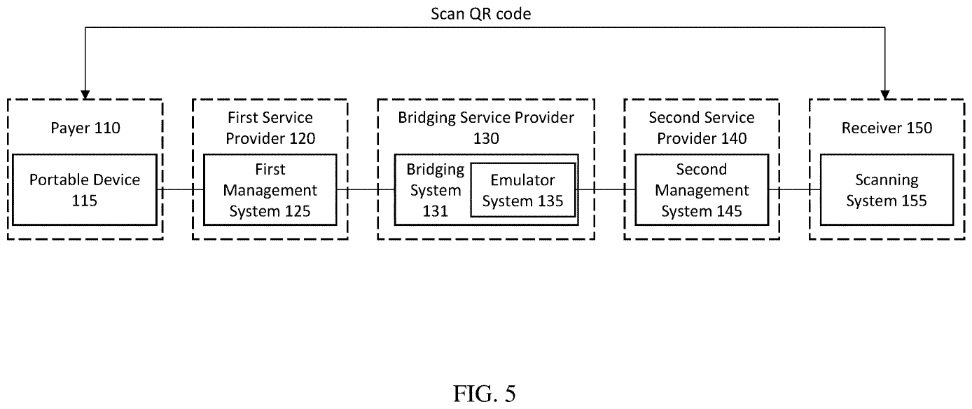

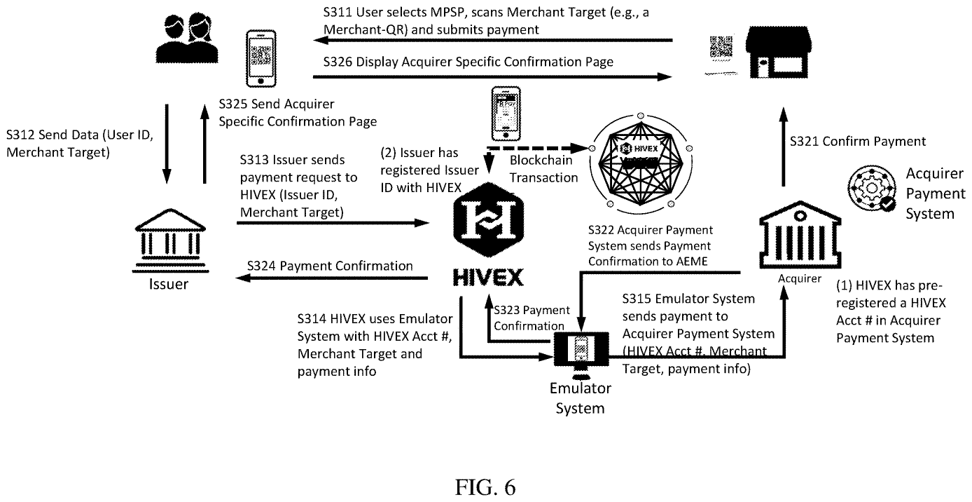

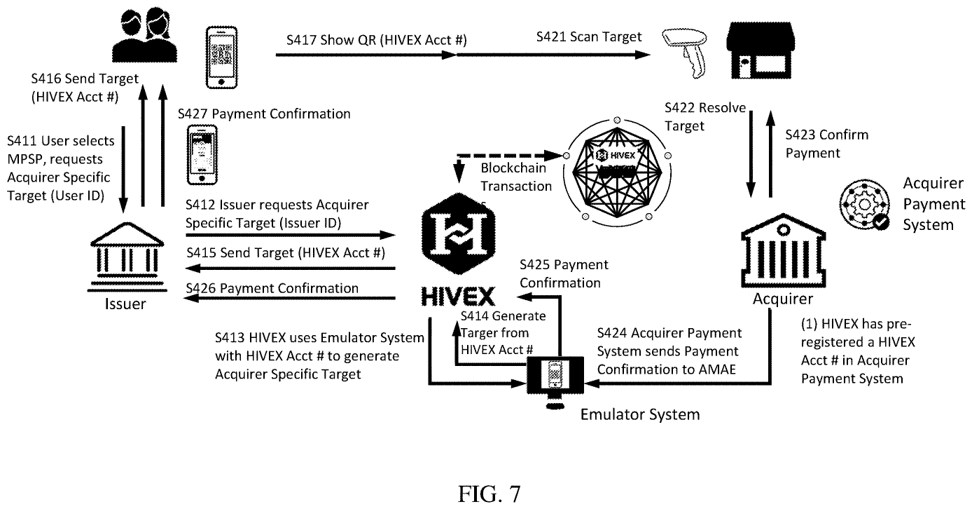

To simplify this problem, a bridging service provider (which is named HIVEX as shown in FIG. 6 and FIG. 7) with a bridging system may be introduced in this case, as shown in FIG. 5. The bridging transaction system comprises three main participants: the first service provider 120 (the issuer), the second service provider 140 (the acquirer), and the bridging service provider 130 (HIVEX). The payer 110 is a user of the first service provider 120 and has a registered account in the first service provider 120. The portable device 115 of the payer 110 is a device having the ability to connect to the Internet and execute programs of the first service provider 120 to present and scan targets (e.g., QR codes). The portable device 115 wirelessly connected to a first management system 125 of the first service provider 120, wherein the first management system 125 is an operating system of the first service provider 120. The bridging service provider 130 (HIVEX) runs an operating system called bridging system 131, which comprises an emulator system 135 to execute bridging transaction-related functions. In this example, it is HIVEX 130 instead of the issuer 120 registered emulator accounts with the acquirer 140.

With HIVEX bridging network, issuers and acquirers just need to join as a member of the network and the transactions can be seamlessly executed. In this variant embodiment, the bridging service provider acts as a “bridge” to link issuers and acquirers, and the emulator system is a part of the bridging system of the bridging service provider, instead of a system of any issuer. However, the steps for performing MPM and CPM transaction are basically the same as described above (in FIG. 2 and FIG. 3), as shown in FIG. 6 (MPM) and FIG. 7 (CPM).

### (A) Merchant Presented Mode

The process for a merchant presented mode (MPM) bridging transaction with bridging service provider is as shown in FIG. 6 and described in detail below. HIVEX (the bridging service provider) has registered emulator accounts with multiple available acquirers, wherein each of the available acquirers has at least one emulator account registered in its network.
S311: This step is analogous to S111. A payer browses on the mobile app to select an acquirer (i.e., select a second service provider) from a list of acceptable MPSPs in a region (e.g., Japan); The payer then scans a merchant target (such as a merchant QR code) and enters the transaction amount then submits the payment. The alternative embodiments described in S111(a) and S111(b) also applied here, except that the merchant target needs to be passed to the bridging system in order to be resolved by the emulator system. In an alternative embodiment, the second service provider may be identified from the multiple acquirers without being selected by the payer. For example, the by second service provider may be identified by the first management system of by the emulator system by performing pattern matching on the target image against an acquirer logo library.
S312: This step is analogous to S112. The payer sends the user ID and merchant target to the first management system (1^{st} MS) of the issuer, along with the transaction amount.
S313: The 1^{st} MS relays the user ID and merchant target to HIVEX (the bridging system).
S314: HIVEX (the bridging system) resolves user ID and records the transaction data in HIVEX's database; then HIVEX uses a bridging account selected from the multiple emulator accounts to log in and perform a transaction use or scan merchant target, with detailed transaction info such as the payment currency and amount.
S315: This step is analogous to S114. The second management system (2^{nd} MS) of the acquirer (the second service provider) performs the payment request using existing processes with user (in bridging account), merchant (resolving merchant target) with other payment info such as currency and amount.
S321: This step is analogous to S121. The 2^{nd} MS confirms payment transaction to merchant if applicable.
S322: This step is analogous to S122. The 2^{nd} MS confirms payment transaction to the emulator system of HIVEX.
S323: HIVEX (the bridging system) extracts payment confirmation from the emulator system sent from the 2^{nd} MS.
S324: HIVEX sends the extracted payment confirmation to the 1^{st} MS.
S325: This step is analogous to S124. The 1^{st} MS sends the payment confirmation to the portable device of the payer. The payment confirmation may be an acquirer specific confirmation page information, which may be generated in the emulator system and transmitted to the portable device via the 1^{st} MS.
S326: This step is analogous to S125. The payer may present the acquirer specific confirmation page information if he/she receives one from the 1^{st} MS, or if the mobile app of the issuer can generate one based on the transaction result. Alternatively, the acquirer specific confirmation page may not be required if the receiver can confirm the transaction result via the merchant device.

### (B) Consumer Presented Mode

The process for a consumer presented mode (CPM) bridging transaction with bridging service provider is as shown in FIG. 7 and described in detail below. Similar to MPM, HIVEX (the bridging service provider) has registered emulator accounts with multiple available acquirers, wherein each of the available acquirers has at least one emulator account registered in its network.
S411: This step is analogous to S211. The payer browses on the mobile app to select an acquirer (select a second service provider) from a list of acceptable MPSPs in a region (e.g., Japan); then the payer requests a target (e.g., a QR code) from the issuer that the receiver (e.g., an acquirer merchant) can scan and accept.
S412: The first management system (1^{st} MS) of the issuer sends target request to HIVEX (the bridging system).
S413: HIVEX sends the target request to emulator system to generate acquirer specific target.
S414: This step is analogous to S213. The emulator system generate a target based on the bridging account selected from the multiple emulator accounts.
S415: HIVEX (the bridging system) sends the generated target to 1^{st} MS of the issuer.
S416: This step is analogous to S214. The 1^{st} MS sends the generated target to the portable device of the payer. Depending on the Acquirer Mobile App setup or the feature implemented by the Issuer, the target can be time based (TTL—Time To Live), tokenized, or encrypted uniquely that only the intended mobile user can decrypt the target.
S417: This step is analogous to S215. The portable device of the payer displays the target to the merchant device (e.g., a merchant POS) of the receiver.
S421: This step is analogous to S221. The receiver scans the target.
S422: This step is analogous to S222. The target or the target content is sent to the second management system (2^{nd} MS) of the acquirer (the second service provider).
S423: This step is analogous to S223. The 2^{nd} MS resolves the target and receiver info and confirms the payment transaction to the receiver.
S424: This step is analogous to S224 and S225. The 2^{nd} MS confirms payment to the emulator system.
S425: This step is analogous to S226. HIVEX extracts payment confirmation from the emulator system.
S426: HIVEX sends the extracted payment confirmation to the 1^{st} MS.
S427: This step is analogous to S227. The portable device of the payer receives payment confirmation(s) from the 1^{st} MS. The payment confirmation(s) may be in the format of the issuer, or in the format of the acquirer, or both. Similar to S125, the payment confirmation in the format of the acquirer is an acquirer specific confirmation page information, which may be generated in the emulator system and transmitted to the portable device via the 1^{st} MS.

Besides the advantages of scalability, the introducing of bridging system as emulator system has additional advantages such as enabling transactions to be written in blockchain. The bridging system (HIVEX) may record the transaction between two different service providers in blockchain to realize features such as immutable and decentralized ledgers, and faster settlement processes. An example facilitating blockchain settlement process is described in PCT International Patent Publication No. WO2018/022131 and incorporated herein by reference.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

What is claimed is:

1. A method for target bridging between a portable device of a payer of a first service provider and a merchant device of a receiver of a second service provider different from the first service provider, comprising:
wirelessly receiving, by a first management system of the first service provider, a target or a target content of the second service provider from a portable device of the payer; and
sending, by the first management system of the first service provider, the target or the target content of the second service provider, to an emulator system, so that the emulator system resolves the target or the target content and transmits the resolved target or the target content of the second service provider to a second management system of the second service provider; wherein:
the portable device is configured to scan the target of the second service provider and transmit the target or the target content of the second service provider to the first management system;
the portable device does not recognize a target of the second service provider; and
the emulator system recognizes a target of the second service provider.

2. The method of claim 1, wherein the target is a QR code.

3. The method of claim 1, before sending the target or the target content of the second service provider to the emulator system further comprising:
identifying, by the first service provider, the second service provider from multiple acquirers.

4. The method of claim 3, wherein the second service provider is identified from the multiple acquirers by receiving an identity information.

5. The method of claim 3, wherein the second service provider is identified from the multiple acquirers by performing pattern matching on the target against an acquirer logo library.

6. The method of claim 1, after sending the target or the target content of the second service provider to the emulator system further comprising:
receiving, by the first management system, a transaction request from the emulator system; and
providing, by the first management system, a transaction approval approving the transaction request to the emulator system.

7. The method of claim 6, after sending the target or the target content of the second service provider to the emulator system further comprising:
receiving, by the first management system, a transaction result from the emulator system;
processing, by the first management system, a payment from the payer to the first service provider corresponding to the transaction result; and
wirelessly providing, by the first management system, the transaction result to the portable device of the payer.

8. The method of claim 1, wherein the emulator system is operated in the first management system.

9. The method of claim 1, wherein the emulator system is operated in a bridging system of a bridging service provider different from the first service provider and the second service provider.

10. The method of claim 1, wherein the emulator system logs in the second management system of the second service provider with a bridging account as a member of the second service provider.

11. The method of claim 10, wherein the bridging account is selected from multiple emulator accounts.

12. A method for target bridging between a portable device of a payer of a first service provider and a merchant device of a receiver of a second service provider different from the first service provider, comprising:
receiving, by a first management system of the first service provider, a target or a target content of the second service provider, from an emulator system; and
wirelessly providing, by the first management system of the first service provider, the target or the target content of the second service provider, to the portable device of the payer to present the target to the merchant device of the receiver of the second service provider; wherein:
the emulator system can generate or receive the target or the target content of the second service provider; and
the merchant device of the receiver does not recognize a target of the first service provider.

13. The method of claim 12, wherein the target is a QR code.

14. The method of claim 12, before receiving the target or the target content of the second service provider further comprising:
wirelessly receiving, by the first management system, a target request from the portable device of the payer for the target of the second service provider; and
providing, by the first management system, the target request to the emulator system.

15. The method of claim 14, before providing the target request to the emulator system further comprising:
identifying, by the first management system, the second service provider from multiple acquirers.

16. The method of claim 15, wherein the second service provider is identified from the multiple acquirers by receiving an identity information.

17. The method of claim 15, wherein the second service provider is identified from the multiple acquirers by performing pattern matching on the target against an acquirer logo library.

18. The method of claim 12, after wirelessly providing the target or the target content of the second service provider to the portable device of the payer to present the target to the merchant device of the receiver further comprising:
receiving, by the first management system, a transaction request from the emulator system after the merchant device of the receiver scans the target; and
providing, by the first management system, a transaction approval approving the transaction request to the emulator system.

19. The method of claim 18, before providing the transaction approval to the emulator system further comprising:
wirelessly providing, by the first management system, the transaction request to the portable device of the payer; and
wirelessly receiving, by the first management system, the transaction approval from the portable device of the payer.

20. The method of claim 12, after wirelessly providing the target or the target content of the second service provider to the portable device of the payer to present the target to the merchant device of the receiver further comprising:
receiving, by the first management system, a transaction result from the emulator system;
processing, by the first management system, a payment from the payer to the first service provider corresponding to the transaction result; and
wirelessly providing, by the first management system, the transaction result to the portable device of the payer.

21. The method of claim 12, wherein the emulator system is operated in the first management system.

22. The method of claim 12, wherein the emulator system is operated in a bridging system of a bridging service provider different from the first service provider and the second service provider.

23. The method of claim 12, wherein the emulator system logs in a second management system of the second service provider with a bridging account as a member of the second service provider.

24. The method of claim 23, wherein the bridging account is selected from multiple emulator accounts.

25. A method for target bridging between a portable device of a payer of a first service provider and a merchant device of a receiver of a second service provider different from the first service provider, comprising:
receiving, by an emulator system, a target or a target content of the second service provider, from a first management system of the first service provider;
resolving, by the emulator system, the target or the target content of the second service provider; and
providing, by the emulator system, the resolved target or the target content of the second service provider, to a second management system of the second service provider, via a bridging account as a member of the second service provider.

26. The method of claim 25, wherein the target is a QR code.

27. The method of claim 25, before receiving the target or the target content of the second service provider from the first management system further comprising:
receiving, by the emulator system, an identity information of the second service provider selected from multiple acquirers.

28. The method of claim 25, after providing the target or the target content of the second service provider to the second management system further comprising:
receiving, by the emulator system, a transaction request from the second management system via the bridging account;
providing, by the emulator system, the transaction request to the first management system;
receiving, by the emulator system, a transaction approval approving the transaction request from the first management system; and
providing, by the emulator system, the transaction approval to the second management system via the bridging account.

29. The method of claim 25, after providing the target or the target content of the second service provider to the second management system further comprising:
receiving, by the emulator system, a transaction result from the second management system via the bridging account; and
providing, by the emulator system, the transaction result to the first management system.

30. The method of claim 25, wherein the emulator system is operated in the first management system.

31. The method of claim 25, wherein the emulator system is operated in a bridging system of a bridging service provider different from the first service provider and the second service provider.

32. The method of claim 27, wherein the emulator system has multiple emulator accounts registered in the multiple acquirers, and the bridging account is selected from the multiple emulator accounts.

33. A method for target bridging between a portable device of a payer of a first service provider and a scanning system of a receiver of a second service provider different from the first service provider, comprising:
retrieving, by an emulator system, a target or a target content of the second service provider via a bridging account as a member of the second service provider; and
providing, by the emulator system, the target or the target content of the second service provider, to the first management system of the first service provider, so that the portable device of the payer presents the target generated based on the target content to the merchant device of the receiver, which recognizes the target of the second service provider;
wherein the merchant device of the receiver does not recognize a target of the first service provider.

34. The method of claim 33, wherein the target is a QR code.

35. The method of claim 33, before retrieving the target or the target content of the second service provider further comprising:
receiving, by the emulator system, a target request from the first management system for the target of the second service provider; and
providing, by the emulator system, the target request to the second service provider via the bridging account.

36. The method of claim 33, wherein an identity of the second service provider selected from multiple acquirers is provided along with the target request, and the bridging account is corresponding to the second service provider.

37. The method of claim 33, after providing the target or the target content of the second service provider to the first management system further comprising:
receiving, by the emulator system, a transaction request from the second management system after the merchant device of the receiver scans the target;
providing, by the emulator system, the transaction request to the first management system;
receiving, by the emulator system, a transaction approval approving the transaction request from the first management system; and
providing, by the emulator system, the transaction approval to the second management system via the bridging account.

38. The method of claim 33, after providing the target or the target content of the second service provider to the first management system further comprising:
receiving, by the emulator system, a transaction result from the second management system via the bridging account; and
providing, by the emulator system, the transaction result to the first management system.

39. The method of claim 33, wherein the emulator system is operated in the first management system.

40. The method of claim 33, wherein the emulator system is operated in a bridging system of a bridging service provider different from the first service provider and the second service provider.

41. The method of claim 36, wherein the emulator system has multiple emulator accounts registered in the multiple acquirers, and the bridging account is selected from the multiple emulator accounts.

42. An emulator system for target bridging between a portable device of a payer of a first service provider and a merchant device of a receiver of a second service provider different from the first service provider, comprising:
an execution module, configured to communicatively connect to at least one issuer management system; and
an emulator module communicatively connected to the execution module, configured to communicatively connect to multiple acquirer management systems;
wherein the execution module comprises instructions stored thereon configured to, in response to execution of the instructions, perform operations comprising:
receiving an input from a first management system, which is one of the at least one issuer management system;
identifying, based on the input, a second management system from the multiple acquirer management systems;
providing, based on the second management system, the input to the emulator module;
receiving an output from the emulator module; and
providing the output to the first management system; and
wherein the emulator module is configured to login the multiple acquirer management systems with multiple emulator accounts, each of which is registered in one of the multiple acquirer management systems.

43. The emulator system of claim 42, wherein the emulator module runs mobile apps of multiple acquirers to login the multiple acquirer management systems.

44. The emulator system of claim 42, wherein the input is a target request, and the output is a target or a target content of the second management system.

45. The emulator system of claim 42, wherein the input is a target or a target content of the second management system, and the output is a payment request initiated by the second management system.

46. The emulator system of claim 42, wherein any of the multiple acquirer management systems does not recognize a target of each other's.

47. The emulator system of claim 42, wherein the emulator system is configured to record an identity of the first management system and an identity of the payer upon receiving the input.
